(19) United States
(12) Patent Application Publication
(10) Pub. No.: US 2016/0353485 A1
(43) Pub. Date: Dec. 1, 2016

(54) MANAGING MEDIUM ACCESS FOR WIRELESS DEVICES

(71) Applicant: QUALCOMM Incorporated, San Diego, CA (US)

(72) Inventor: Maarten Menzo Wentink, Naarden (NL)

(21) Appl. No.: 15/163,562

(22) Filed: May 24, 2016

Related U.S. Application Data
(60) Provisional application No. 62/166,659, filed on May 26, 2015.

(51) Int. Cl. H04W 74/08; H04W 74/06; H04W 72/14

(52) U.S. Cl. CPC H04W 74/0833; H04W 72/14; H04W 74/06; H04W 84/12

(57) ABSTRACT

Apparatuses and methods are disclosed for managing access to a wireless medium. In one example, a first wireless device contends for access to the wireless medium using a random channel access mechanism, and then obtain a medium resource unit (MRU) for a master transmit opportunity (TXOP) duration. The first wireless device, which controls medium access for the master TXOP duration, may transmit data on the wireless medium using the obtained MRU and/or may grant medium access via the obtained MRU to a number of second wireless devices.

### CROSS-REFERENCE TO RELATED APPLICATION

This application claims priority to co-pending and commonly owned U.S. Provisional Patent Application No. 62/166,659 entitled “RANDOM ACCESS RULES” filed on May 26, 2015, the entirety of which is incorporated by reference herein.

### TECHNICAL FIELD

The example embodiments relate generally to wireless networks, and specifically to the coexistence of wireless devices that employ different channel access mechanisms.

### BACKGROUND OF RELATED ART

A WiFi® network may be formed by one or more access points (APs) that provide a wireless communication channel or link with a number of client devices or stations (STAs). Each AP, which may correspond to a Basic Service Set (BSS), periodically broadcasts beacon frames to enable any STAs within wireless range of the AP to establish and/or maintain a communication link with the Wi-Fi network. The beacon frames, which may include a traffic indication map (TIM) indicating whether the AP has queued downlink data for the STAs, are typically broadcast according to a target beacon transmission time (TBTT) schedule.

In many wireless local area networks (WLANs), only one device may use the shared wireless medium at any given time. To arbitrate access to the shared wireless medium, the IEEE 802.11 standards provide Carrier Sense Multiple Access with Collision Avoidance (CSMA/CA) techniques that allow wireless devices to randomly access the wireless medium in a manner that minimizes collisions. For example, to prevent multiple devices from accessing the wireless medium at the same time, each device may contend for medium access using a random channel access mechanism that uses an exponential back-off procedure.

The IEEE 802.11ax standards may introduce multiple access mechanisms that allow multiple devices to transmit and/or receive data on a shared wireless medium at the same time. For example, in a multiple access wireless network, the available frequency spectrum may be divided into a plurality of resource units (RUs) each including a number of different frequency subcarriers, and different RUs may be allocated or assigned to different wireless devices at a given point in time. In this manner, multiple wireless devices may concurrently transmit data on the wireless medium using their assigned RU or frequency subcarriers. Further, in contrast to conventional wireless networks in which wireless devices typically contend with each other for medium access, wireless networks operating according to the IEEE 802.11ax standards may allow medium access to be scheduled for the wireless devices, for example, to reduce transmission latencies associated with medium access contention operations.

When a wireless medium is shared by a number of older wireless devices that employ random channel access mechanisms and by a number of newer wireless devices for which medium access is scheduled, operation of the older wireless devices may interfere with operation of the newer wireless devices. In addition, operation of the newer wireless devices may interfere with operation of the older wireless devices. Thus, it would be desirable for newer wireless devices that receive scheduled grants of medium access to co-exist on the same wireless medium as older wireless devices that employ random channel access mechanisms.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Apparatuses and methods are disclosed for managing access to a shared wireless medium in a wireless network. In one example, a method for managing access to a shared wireless medium in a wireless network is disclosed. The method, which may be performed by a first wireless device, may include contending for access to the wireless medium using a random channel access mechanism; obtaining a medium resource unit (MRU) for a master transmit opportunity (TXOP) duration based on the contending; selectively transmitting data on the wireless medium, using the obtained MRU, during a first interval of the master TXOP duration; and scheduling a grant of the obtained MRU to a second wireless device during a second interval of the master TXOP duration.

In another example, a first wireless device for managing access to a shared wireless medium in a wireless network is disclosed. The first wireless device may include one or more processors and a memory storing instructions that, when executed by the one or more processors, cause the first wireless device to contend for access to the wireless medium using a random channel access mechanism; obtain a medium resource unit (MRU) for a master transmit opportunity (TXOP) duration based on the contending; selectively transmit data on the wireless medium, using the obtained MRU, during a first interval of the master TXOP duration; and schedule a grant of the obtained MRU to a second wireless device during a second interval of the master TXOP duration.

In another example, a non-transitory computer-readable storage medium is disclosed. The non-transitory computer-readable storage medium may be configured to store instructions that, when executed by one or more processors of a first wireless device, cause the first wireless device to manage access to a shared wireless medium by performing operations that include contending for access to the wireless medium using a random channel access mechanism; obtaining a medium resource unit (MRU) for a master transmit opportunity (TXOP) duration based on the contending; selectively transmitting data on the wireless medium, using the obtained MRU, during a first interval of the master TXOP duration; and scheduling a grant of the obtained MRU to a second wireless device during a second interval of the master TXOP duration.

In another example, a first wireless device for managing access to a shared wireless medium in a wireless network is disclosed. The first wireless device may include means for contending for access to the wireless medium using a random channel access mechanism; means for obtaining a medium resource unit (MRU) for a master transmit opportunity (TXOP) duration based on the contending; means for selectively transmitting data on the wireless medium, using the obtained MRU, during a first interval of the master TXOP duration; and means for scheduling a grant of the obtained MRU to a second wireless device during a second interval of the master TXOP duration.

### BRIEF DESCRIPTION OF THE DRAWINGS

The example embodiments are illustrated by way of example and are not intended to be limited by the figures of the accompanying drawings. Like numbers reference like elements throughout the drawings and specification.

FIG. 1 shows an example wireless system within which the example embodiments may be implemented.

FIG. 2 shows a block diagram of a wireless station (STA) in accordance with example embodiments.

FIG. 3 shows a block diagram of an access point (AP) in accordance with example embodiments.

FIG. 4 is a graph depicting an example relationship between a number of devices contending for medium access and average random times between transmission opportunities (TXOPs) associated with medium resource units (MRUs).

FIG. 5 is a timing diagram depicting an example operation for managing access to a wireless medium, in accordance with example embodiments.

FIG. 6 is a timing diagram depicting another example operation for managing access to a wireless medium, in accordance with example embodiments.

FIG. 7 is a timing diagram depicting yet another example operation for managing access to a wireless medium, in accordance with example embodiments.

FIG. 8 shows an illustrative flow chart depicting an example operation for managing access to a shared wireless medium, in accordance with example embodiments.

FIG. 9A shows an illustrative flow chart depicting an example operation for granting access to the shared wireless medium to one or more other wireless devices, in accordance with example embodiments.

FIG. 9B shows an illustrative flow chart depicting another example operation for granting access to the shared wireless medium to one or more other wireless devices, in accordance with example embodiments.

FIG. 10 shows an illustrative flow chart depicting an example operation for selecting between channel access mechanisms, in accordance with example embodiments.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH® (Bluetooth or BT), HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “number” as used herein may refer to an integer value greater than or equal to zero. The term “medium access” as used herein may refer to gaining and/or controlling access to a shared wireless medium. The term “transmit opportunity” (TXOP) as used herein may refer to a period of time during which a device may transmit data via the shared wireless medium.

Further, as used herein, the term “HT” may refer to “High Throughput,” such as a high throughput frame format or protocol defined, for example, by the IEEE 802.11n standards. The term “VHT” may refer to “Very High Throughput,” such as a very high throughput frame format or protocol defined, for example, by the IEEE 802.11ac standards. The term “HE” may refer to “High Efficiency,” such as a high efficiency frame format or protocol defined, for example, by the IEEE 802.11ax standards. In addition, the term “HE device” may refer to a high efficiency wireless device capable of operating according to protocols defined by the IEEE 802.11ax standards, the term “HE STA” may refer to a wireless station capable of operating according to protocols defined by the IEEE 802.11ax standards, and the term “HE AP” may refer to a wireless access point capable of operating according to protocols defined by the IEEE 802.11ax standards. Thus, for at least some implementations, the term “HE device” as used herein may refer to a HE STA and/or a HE AP.

The term “non-HE” may refer to a legacy frame format or protocol defined, for example, by the IEEE 802.11a/b/g/n/ac standards. Further, the term “non-HE STA” may refer to a wireless station that may operate in accordance with the IEEE 802.11a/b/g/n/ac standards but not the IEEE 802.11ax standards, the term “non-HE AP” may refer to a wireless access point that may operate in accordance with the IEEE 802.11a/b/g/n/ac standards but not the IEEE 802.11ax standards, and the term “non-HE device” may refer to a wireless device that may operate in accordance with the IEEE 802.11a/b/g/n/ac standards but not the IEEE 802.11ax standards. Thus, for at least some implementations, the term “non-HE device” as used herein may refer to a non-HE STA and/or a non-HE AP. Accordingly, in some aspects, the terms “non-HE device,” “legacy device,” “non-HE STA,” and “non-HE AP” may be used interchangeably herein.

Also, in the following description and for purposes of explanation, specific nomenclature is set forth to provide a thorough understanding of the example embodiments. However, it will be apparent to one skilled in the art that these specific details may not be required to practice the example embodiments. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components.

As mentioned above, in many WLANs, only one device may use a shared wireless medium at any given time. To arbitrate access to the shared wireless medium, the IEEE 802.11 standards define a distributed coordination function (DCF) that instructs individual STAs (and APs) to “listen” to the wireless medium to determine when the wireless medium is idle (e.g., using a “carrier sense” technique). For example, only when a STA detects that the wireless medium has been continuously idle for a DCF Interframe Space (DIFS) duration may the STA attempt to transmit data on the wireless medium. To prevent multiple devices from accessing the wireless medium at the same time, each device may select a random “back-off” number or period. More specifically, during a contention period, each device waits for a period of time determined by its back-off number (e.g., its back-off period) before it attempts to transmit data on the wireless medium. The device that selects the lowest back-off number “wins” the contention operation, and may be granted access to the shared wireless medium for a period of time commonly referred to as a transmit opportunity (TXOP). If multiple devices select the same back-off value and then attempt to transmit data at the same time, a collision occurs and the devices contend for medium access again using an exponential back-off procedure.

Data may be selected for transmission over the shared wireless medium according to priority levels, for example, so that higher priority data (e.g., voice data) may be allocated higher transmission priorities than lower priority data (e.g., emails). More specifically, data of different priority levels may be assigned different ranges of back-off numbers so that higher priority data is more likely to win a given medium access contention operation than lower priority data (e.g., by assigning lower back-off numbers to higher priority data and assigning higher back-off numbers to lower priority data). The different ranges of back-off numbers may be allocated to different priority levels of data by classifying data into access categories, and then providing a different range of back-off numbers to each access category (AC).

For example, data may be assigned to one of four access categories (AC0-AC3), for example, based on latency and/or time sensitivity requirements of the data: the highest priority data (e.g., voice data such as for a VoIP call) may be assigned to the first access category (AC0); the second highest priority data (e.g., video data) may be assigned to the second access category (AC1); the third highest priority data (e.g., data associated with a “best effort” QoS) may be assigned to the third access category (AC2); and the lowest priority data (e.g., “background” data) may be assigned to the fourth access category (AC3). Although described herein with respect to four access categories AC0-AC3, the example embodiments are applicable to systems that may include other numbers of access categories or priority levels. More specifically, for at least some embodiments, the access categories AC0-AC3 described herein may correspond to the access categories AC_VO, AC_VI, AC_BE, and AC_BK, respectively, associated with one or more of the IEEE 802.11 standards.

According to the enhanced distributed coordination channel access (EDCA) function described in the IEEE 802.11 standards, each STA is to include a different transmit queue for each access category (AC), and the transmit queues are to independently contend for medium access. Because the AP may serve multiple STAs at the same time, the AP may include a plurality of transmit queues for each AC. More specifically, the AP may classify downlink data (e.g., data to be transmitted to one or more of its associated STAs) based on a traffic identifier (TID) and a destination address (DA). The destination address (DA) indicates to which STA the data is to be transmitted. The TID indicates the priority level of the data and may thus be mapped to a corresponding access category. By classifying downlink data according to its TID and DA, the AP may aggregate data of the same priority level in a common set of AC queues that select from a corresponding range of back-off numbers. The aggregated data may be transmitted over the wireless medium as aggregated data frames such as, for example, aggregated MAC protocol data units (A-MPDUs) and/or aggregated MAC service data units (A-MSDUs).

As mentioned above, the IEEE 802.11ax standards may employ multiple access mechanisms, such as orthogonal frequency-division multiple access (OFDMA) techniques, to allow multiple devices to transmit and/or receive data on a shared wireless medium at the same time. The available frequency spectrum of an OFDMA-based wireless network may be divided into a plurality of resource units (RUs) each including a number of different frequency subcarriers, and different RUs may be allocated or assigned to different wireless devices at a given point in time. In this manner, multiple wireless devices may concurrently transmit data on the wireless medium using their assigned RU or frequency subcarriers.

Access to the wireless medium of an OFDMA-based wireless network may be scheduled to avoid (or at least reduce) collisions. For example, an AP operating in an OFDMA-based wireless network may select the size and location of an RU upon which each STA may transmit data, and may inform each STA of its assigned RU in a trigger frame. In addition to allocating unique RUs to different STAs, the trigger frames may also schedule uplink (UL) transmissions from the different STAs, for example, to avoid the use of random contention operations for medium access.

As mentioned above, the operation of newer devices (e.g., HE devices) may be adversely affected by the operation of older or legacy devices (e.g., non-HE devices) on the same channel or wireless medium. For example, because legacy devices that employ random channel access mechanisms may not be aware of scheduled grants of medium access to HE devices, medium access contention operations performed by legacy devices may interfere with scheduled grants of medium access to HE devices. In addition, the operation of legacy devices may be adversely affected by the operation of HE devices on the same channel or wireless medium. For example, the scheduled grants of medium access to HE devices may increase the likelihood of collisions during medium access contention operations performed by legacy devices. These are at least some of the technical problems to be solved by the example embodiments.

Apparatuses and methods are disclosed that may allow legacy devices that employ random channel access mechanisms to co-exist on the same wireless medium with HE devices for which grants of medium access may be scheduled. In accordance with example embodiments, legacy devices and HE devices may contend for medium access using a random channel access mechanism to obtain a medium resource unit (MRU). The MRU may be used by the device that obtained the MRU (e.g., denoted herein as the master device) for data transmissions and/or may be granted to one or more other wireless devices (e.g., denoted herein as slave devices) for data transmissions. In this manner, HE devices may co-exist on the same wireless medium as legacy devices, and wireless networks that include HE devices may operate in a manner that is backwards compatible with legacy devices. These and other details of the example embodiments, which provide one or more technical solutions to the aforementioned technical problems, are described in more detail below.

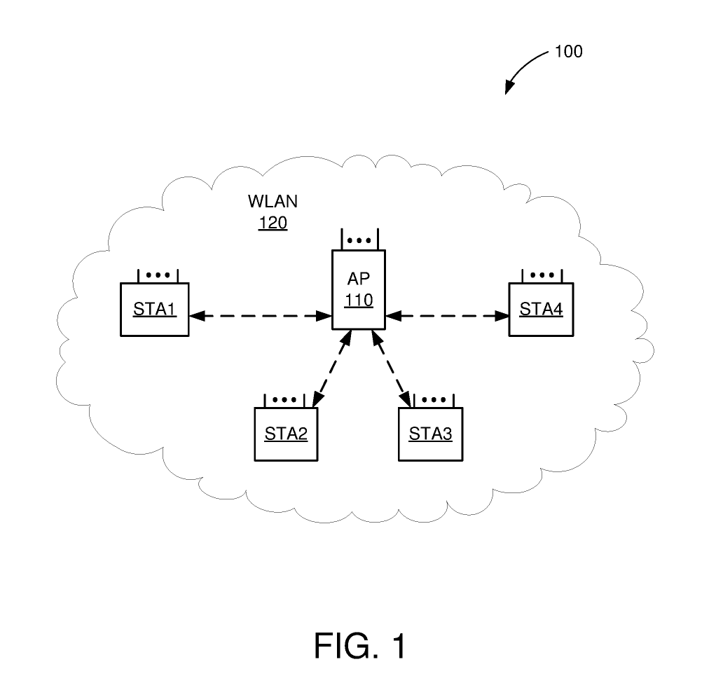

FIG. 1 is a block diagram of a wireless system 100 within which the example embodiments may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique media access control (MAC) address that is programmed therein by, for example, the manufacturer of the access point. Similarly, each of stations STA1-STA4 is also assigned a unique MAC address. For some embodiments, the wireless system 100 may correspond to a multiple-input multiple-output (MIMO) wireless network. Further, although the WLAN 120 is depicted in FIG. 1 as an infrastructure BSS, for other example embodiments, WLAN 120 may be an independent basic service set (IBSS), an ad-hoc network, or a peer-to-peer (P2P) network (e.g., operating according to the Wi-Fi Direct protocols).

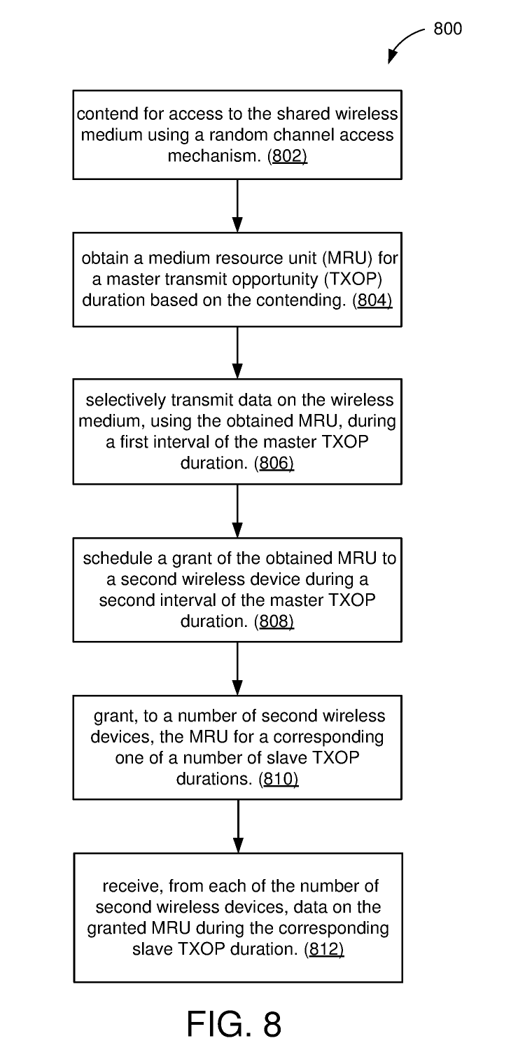

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8, 9A-9B, and 10.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8, 9A-9B, and 10.

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol).

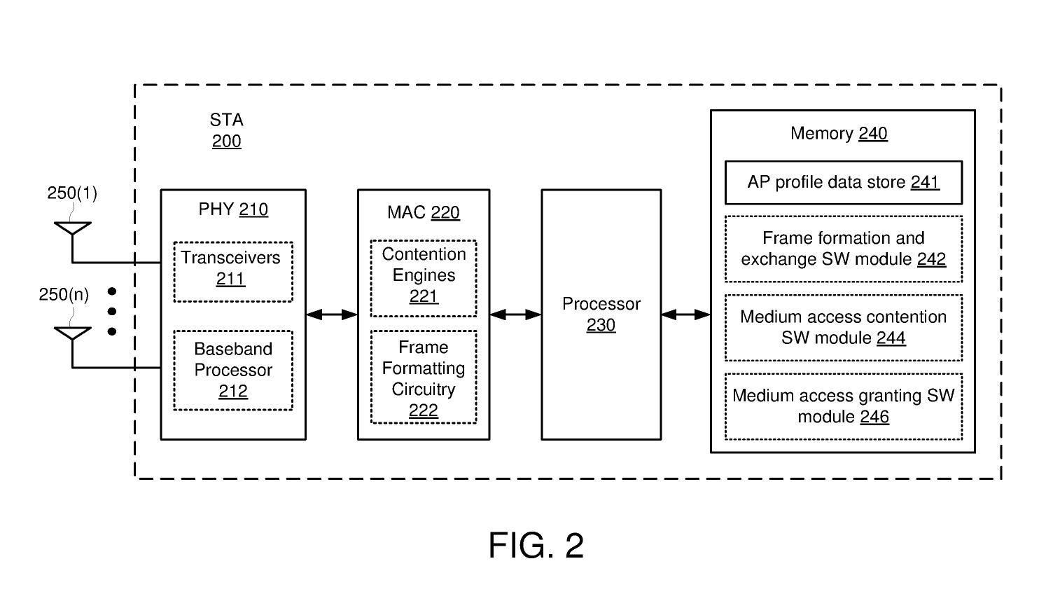

FIG. 2 shows an example STA 200 that may be one embodiment of one or more of the stations STA1-STA4 of FIG. 1. The STA 200 may include a physical layer device (PHY) 210, a media access control layer (MAC) 220, a processor 230, a memory 240, and a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110 and/or other STAs (see also FIG. 1), and may be used to scan the surrounding environment to detect and identify nearby access points and/or other STAs (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for MIMO operations. The MIMO operations may include single-user MIMO (SU-MIMO) operations and multi-user MIMO (MU-MIMO) operations. The STA 200 may also be configured for uplink (UL) transmissions using UL OFDMA communications and/or UL MU-MIMO communications, and may be configured to receive downlink (DL) data using OFDMA communications, MU-MIMO communications, and/or MD-AMPDUs.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

The MAC 220 may include at least a number of contention engines 221 and frame formatting circuitry 222. The contention engines 221 may contend for access to one more shared wireless mediums, and may also store packets for transmission over the one more shared wireless mediums. The STA 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220).

The frame formatting circuitry 222 may be used to create and/or format frames received from processor 230 and/or memory 240 (e.g., by adding MAC headers to PDUs provided by processor 230), and may be used to re-format frames received from PHY 210 (e.g., by stripping MAC headers from frames received from PHY 210).

Processor 230, which is coupled to PHY 210, to MAC 220, and to memory 240, may be any suitable one or more processors capable of executing scripts or instructions of one or more software programs stored in STA 200 (e.g., within memory 240). For purposes of discussion herein, processor 230 is shown in FIG. 2 as being coupled between MAC 220 and memory 240. For actual embodiments, PHY 210, MAC 220, processor 230, and/or memory 240 may be connected together using one or more buses (not shown for simplicity).

Memory 240 may include an AP profile data store 241 that stores profile information for a plurality of APs. The profile information for a particular AP may include, for example, the AP's service set identifier (SSID), MAC address, channel information, received signal strength indicator (RSSI) values, goodput values, channel state information (CSI), supported data rates, supported channel access mechanisms, connection history with STA 200, a trustworthiness value of the AP (e.g., indicating a level of confidence about the AP's location, etc.), and any other suitable information pertaining to or describing the operation of the AP.

Memory 240 may also include a non-transitory computer-readable medium (e.g., one or more nonvolatile memory elements, such as EPROM, EEPROM, Flash memory, a hard drive, and so on) that may store at least the following software (SW) modules:
a frame formation and exchange software module 242 to facilitate the creation and exchange of any suitable frames (e.g., data frames, control frames, and management frames) between STA 200 and other wireless devices, for example, as described below for one or more operations of FIGS. 8, 9A-9B, and 10;
a medium access contention software module 244 to contend for and obtain one or more medium resource units (MRUs) in accordance with example embodiments, for example, as described below for one or more operations of FIGS. 8, 9A-9B, and 10; and
a medium access granting software module 246 to grant a portion (or all) of an obtained MRU to one or more other wireless devices, for example, as described below for one or more operations of FIGS. 8, 9A-9B, and 10.
   Each software module includes instructions that, when executed by processor 230, cause STA 200 to perform the corresponding functions. The non-transitory computer-readable medium of memory 240 thus includes instructions for performing all or a portion of the STA-side operations described below with respect to FIGS. 8, 9A-9B, and 10.

Processor 230 may execute the frame formation and exchange software module 242 to facilitate the creation and exchange of any suitable frames (e.g., data frames, control frames, and management frames) between STA 200 and other wireless devices. Processor 230 may execute the medium access contention software module 244 to contend for and obtain one or more MRUs in accordance with example embodiments. Processor 230 may execute the medium access granting software module 246 to grant a portion (or all) of an obtained MRU to one or more other wireless devices. In some aspects, the STA 200 may grant medium access via the obtained MRU to the one or more other wireless devices using a polling mechanism. In other aspects, the STA 200 may grant medium access via the obtained MRU to the one or more other wireless devices using a scheduling mechanism.

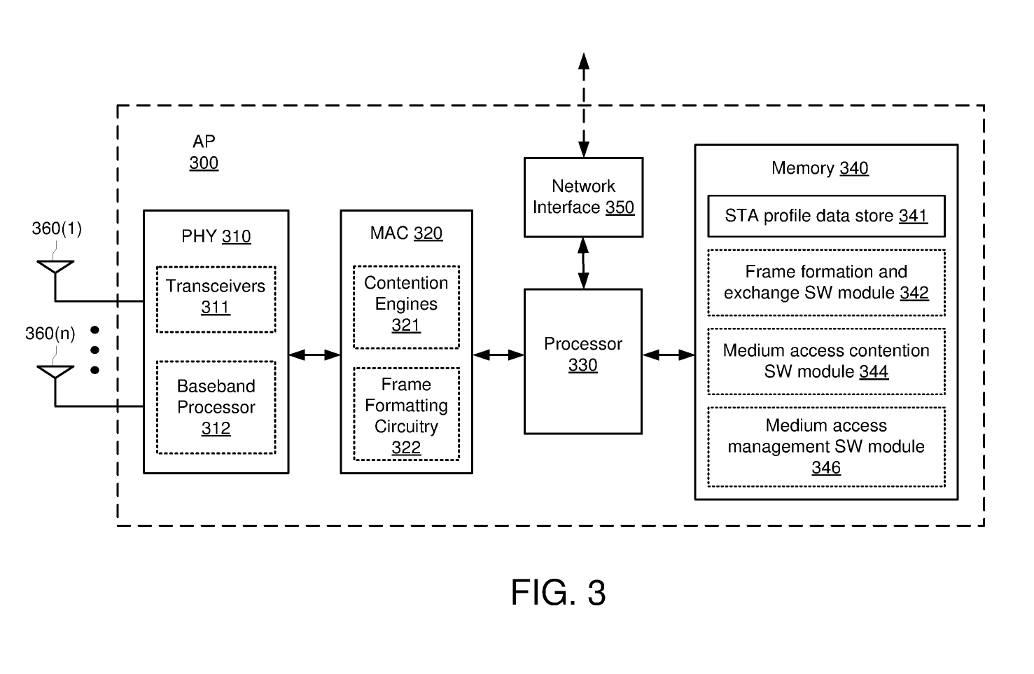

FIG. 3 shows an example AP 300 that may be one embodiment of the AP 110 of FIG. 1. The AP 300 may include a PHY 310, a MAC 320, a processor 330, a memory 340, a network interface 350, and a number of antennas 360(1)-360(n). The transceivers 311 may be coupled to antennas 360(1)-360(n), either directly or through an antenna selection circuit (not shown for simplicity). The transceivers 311 may be used to communicate wirelessly with one or more STAs, with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). Thus, for example embodiments, the AP 300 may be configured for MIMO operations including, for example, SU-MIMO operations and MU-MIMO operations. The AP 300 may also be configured for uplink (UL) transmissions using UL OFDMA communications and/or UL MU-MIMO communications, and may be configured to receive DL data using OFDMA communications, MU-MIMO communications, and/or MD-AMPDUs.

The baseband processor 312 may be used to process signals received from processor 330 and/or memory 340 and to forward the processed signals to transceivers 311 for transmission via one or more of antennas 360(1)-360(n), and may be used to process signals received from one or more of antennas 360(1)-360(n) via transceivers 311 and to forward the processed signals to processor 330 and/or memory 340.

The MAC 320 may include at least a number of contention engines 321 and frame formatting circuitry 322. The contention engines 321 may contend for access to the shared wireless medium, and may also store packets for transmission over the shared wireless medium. For some embodiments, AP 300 may include one or more contention engines 321 for each of a plurality of different access categories. For other embodiments, the contention engines 321 may be separate from MAC 320. For still other embodiments, the contention engines 321 may be implemented as one or more software modules (e.g., stored in memory 340 or within memory provided within MAC 320).

The frame formatting circuitry 322 may be used to create and/or format frames received from processor 330 and/or memory 340 (e.g., by adding MAC headers to PDUs provided by processor 330), and may be used to re-format frames received from PHY 310 (e.g., by stripping MAC headers from frames received from PHY 310).

Processor 330, which is coupled to PHY 310, to MAC 320, to memory 340, and to network interface 350, may be any suitable one or more processors capable of executing scripts or instructions of one or more software programs stored in AP 300 (e.g., within memory 340). For purposes of discussion herein, processor 330 is shown in FIG. 3 as being coupled between MAC 320 and memory 340. For actual embodiments, PHY 310, MAC 320, processor 330, memory 340, and/or network interface 350 may be connected together using one or more buses (not shown for simplicity).

The network interface 350 may be used to communicate with a WLAN server (not shown for simplicity) either directly or via one or more intervening networks and to transmit signals.

Memory 340 may include a STA profile data store 341 that stores profile information for a plurality of STAs. The profile information for a particular STA may include, for example, its MAC address, supported data rates, supported channel access mechanisms, connection history with AP 300, and any other suitable information pertaining to or describing the operation of the STA.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formation and exchange software module 342 to facilitate the creation and exchange of any suitable frames (e.g., data frames, control frames, and management frames) between AP 300 and other wireless devices, for example, as described below for one or more operations of FIGS. 8, 9A-9B, and 10;
a medium access contention software module 344 to contend for and obtain one or more medium resource units (MRUs) in accordance with example embodiments, for example, as described below for one or more operations of FIGS. 8, 9A-9B, and 10; and
a medium access granting software module 346 to grant a portion (or all) of an obtained MRU to one or more other wireless devices, for example, as described below for one or more operations of FIGS. 8, 9A-9B, and 10.
   Each software module includes instructions that, when executed by processor 330, cause AP 300 to perform the corresponding functions. The non-transitory computer-readable medium of memory 340 thus includes instructions for performing all or a portion of the AP-side operations described below with respect to FIGS. 8, 9A-9B, and 10.

Processor 330 may execute the medium access contention software module 344 to contend for and obtain one or more MRUs in accordance with example embodiments. Processor 330 may execute the medium access granting software module 346 to grant a portion (or all) of an obtained MRU to one or more other wireless devices. In some aspects, the AP 300 may grant medium access via the obtained MRU to the one or more other wireless devices using a polling mechanism. In other aspects, the AP 300 may grant medium access via the obtained MRU to the one or more other wireless devices using a scheduling mechanism.

As mentioned above, it would be desirable for legacy devices that employ random channel access mechanisms to co-exist on the same wireless medium with HE devices for which grants of medium access may be scheduled. Thus, in accordance with example embodiments, access to a wireless medium of a wireless network including legacy devices and HE devices may be based on obtaining and/or receiving grants of medium resource units (RMUs) upon which wireless devices may transmit data.

More specifically, for at least some implementations, a first wireless device such as a STA or an AP may contend for access to the wireless medium using a random channel access mechanism, and then obtain a medium resource unit (MRU) for a master transmit opportunity (TXOP) duration. The first wireless device may then control the wireless medium during the master TXOP duration (e.g., as the master device). If the first wireless device has queued data for transmission, the first wireless device may transmit the data using the obtained MRU during a first interval of the master TXOP duration. After transmitting the data, the first wireless device may schedule a grant of the obtained MRU to each of a number of second wireless devices (e.g., as slave devices) during a second interval of the master TXOP duration. Specifically, the first wireless device may grant, to each of the second wireless devices, the MRU for a corresponding one of a number of slave TXOP durations. Each of the second wireless devices that receives a MRU grant may then transmit data on the wireless medium during a corresponding slave TXOP duration. For other implementations, the first wireless device may reserve the obtained MRU for its own data transmissions for the entire master TXOP duration.

If the first wireless device does not have queued data for transmission, the first wireless device may schedule a grant of the obtained MRU to one or more of the second wireless devices during at least part of the first interval of the master TXOP duration. Specifically, the first wireless device may grant, to each of the second wireless devices, the MRU for a corresponding one of a number of slave TXOP durations (e.g., which may include a portion of the master TXOP duration). Each of the second wireless devices that receives a MRU grant may then transmit data on the wireless medium.

For example embodiments, obtaining an MRU and/or granting the MRU to other wireless devices may be based on the following rules:
Medium access is granted by contending for medium resource units (MRUs).
MRUs are obtained using random channel access mechanisms.
A device that obtains an MRU controls the wireless medium as a master device for the duration of the MRU, and may grant medium access to another device (as a slave device) for a portion of the duration of the obtained MRU.
The master device may grant a TXOP within the obtained MRU to a slave device using either a polling mechanism or a scheduling mechanism.
The minimum time between MRUs may be 40 micro-seconds (us). The average time between MRUs may depend on the number of devices contending for medium access.
The duration of the MRU for a master device may be less than 20 milliseconds (ms). The duration of the MRU granted to a slave device may be less than 4 ms.
The idle time during a given MRU may be less than or equal to 25 us.

For other embodiments, the minimum time between MRUs, the duration of the MRU for a master device, the duration of the MRU for a slave device, and/or the idle time during a given MRU may be other suitable values.

In addition, for at least some embodiments, obtaining an MRU and/or granting the MRU to other wireless devices may also be based on the following additional rules:
The minimum time between TXOPs may be 43 μs, for example, based on an arbitration interframe spacing (AIFS) duration of 3 μs for the “best effort” access category. The average random time between TXOPs may be 75/n+47 μs, where n is the number of devices contending for medium access.
Different traffic priorities (e.g., different access categories) may have independent channel access mechanisms with n-to-gap curves and minimum gaps.
The default channel width is 20 MHz. Allowed channel widths are 20 MHz, 40 MHz, 80 MHz, and 160 MHz.
Secondary channel TXOPs are preceded by a 25 is idle time for clear channel assessment (CCA) operations (e.g., which may occur during the PIFS duration preceding the end of a contention period).
Primary channels are co-located on the same channel.
CCA operations are based on the following:
   energy detect (ED).
   carrier sense (CS) from a legacy signaling (L-SIG) field of a packet.
   Network Allocation Vector (NAV) from Ready-to-Send (RTS) frames, Clear-to-Send (CTS) frames, acknowledgements (ACKs), and block acknowledgements (BAs) at 6 Mbps, 12 Mbps, and 24 Mbps for OFDM signaling.

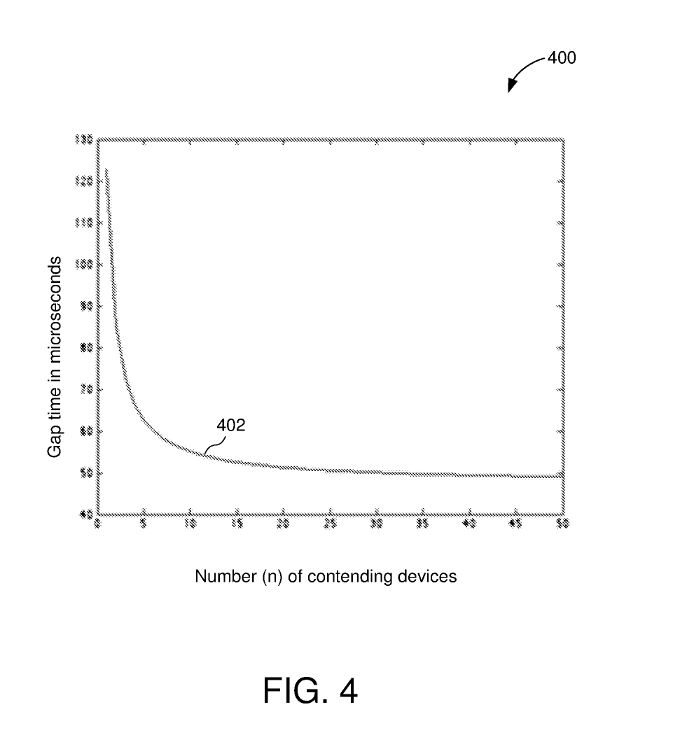

FIG. 4 is a graph 400 depicting an example relationship between the number of devices contending for medium access and the average gap time between TXOPs, in accordance with some embodiments. More specifically, the graph 400 is shown to include a curve 402 that indicates the average gap time (in microseconds) as a function of the number (n) of devices contending for medium access. For the example of FIG. 4, the curve 402 is based on wireless device contending for medium access using EDCA techniques with an exponential back-off collision avoidance for the Best Effort access category. As depicted in FIG. 4, the average gap time between TXOPs decreases as the number of contending devices increases, and the average gap time between TXOPs increases as the number of contending devices decreases.

For some implementations, a wireless device may select either a schedule-based channel access mechanism or a random channel access mechanism based, at least in part, on channel conditions and/or network requirements. For one example, while random channel access mechanisms may involve AP polling operations, schedule-based channel access mechanisms do not involve AP polling operations, and therefore typically use less overhead for grants of medium access than random channel access mechanisms. As a result, schedule-based medium access mechanisms may be more efficient than random channel access mechanisms for wireless networks that include static nodes and/or that have static traffic patterns. However, when a wireless network includes dynamic nodes and/or has changing channel conditions, the polling operations utilized by random channel access mechanisms may provide an indication of channel conditions. As a result, random channel access mechanisms may be less susceptible to interference and changing channel conditions than schedule-based medium access mechanisms, and therefore may be more efficient than schedule-based medium access mechanisms when interference levels are above a threshold and/or when channel conditions change by more than an amount.

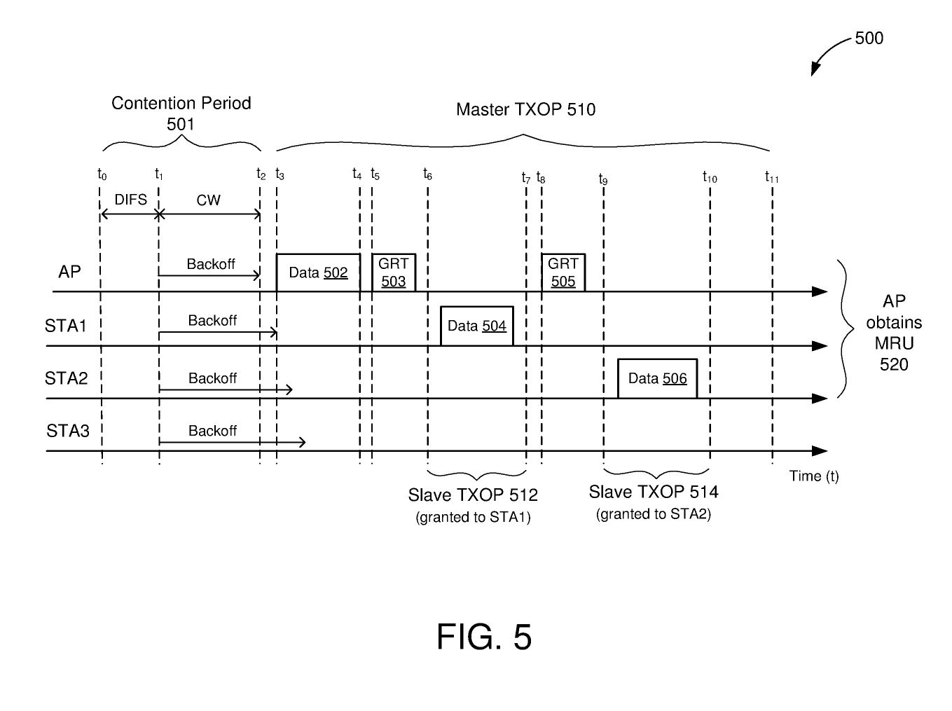

FIG. 5 is a timing diagram depicting an example operation 500 for managing access to a wireless medium, in accordance with example embodiments. For the example of FIG. 5, the AP may be any suitable AP including, for example, the AP 110 of FIG. 1 and/or the AP 300 of FIG. 3. Each of the stations STA1-STA3 may be any suitable wireless station including, for example, the stations STA1-STA4 of FIG. 1 and/or the STA 200 of FIG. 2.

As depicted in FIG. 5, the AP obtains a medium resource unit (MRU) 520 for a master TXOP duration 510, and may control medium access via the MRU 520 for the master TXOP duration 510. More specifically, the AP and stations STA1-STA3 may contend with each other for medium access during a contention period 501. After sensing that the wireless medium has been continuously idle for a DIFS interval between times t₀ and t₁, the AP and stations STA1-STA3 may each select a random back-off number. After a back-off period determined by its selected back-off number, each of the AP and stations STA1-STA3 may then attempt to gain access to the wireless medium. For the example of FIG. 5, the AP has the shortest back-off period (e.g., corresponding to a contention window (CW) between times t₁ and t₂), and gains access to the wireless medium at time t₂. Thus, at time t₂, the AP may obtain the MRU 520 for the master TXOP duration 510 between times t₃ and t₁₁.

The AP may transmit data using the obtained MRU 520 and/or may selectively schedule a grant of the obtained MRU 520 to stations STA1-STA3 during the master TXOP duration 510. For the example of FIG. 5, the AP transmits data 502 on the wireless medium during a first interval (e.g., between times t₃ and t₄) of the master TXOP duration 510. After transmitting the data 502, the AP may schedule a grant of the obtained MRU 520 to stations STA1-STA3 during a second interval of the obtained master TXOP duration 510 (e.g., during a remainder of the master TXOP duration 510 between times t₆ and t₁₁). For other implementations, the AP may grant medium access to stations STA1-STA3 using a polling operation.

For the example of FIG. 5, the AP transmits a first grant message 503 to STA1 at time t₅. The first grant message 503 may grant the MRU 520 to STA1 for a first portion of the second interval of the master TXOP duration 510. In some aspects, the AP grants STA1 medium access for a slave TXOP duration 512 between times t₆ and t₇. STA1 transmits data 504 using the MRU 520 during the slave TXOP duration 512. After expiration of the slave TXOP duration 512 at time t₇, control of the wireless medium returns to the AP.

At time t₈, the AP transmits a second grant message 505 to STA2. The second grant message 505 may grant the MRU 520 to STA2 for a second portion of the second interval of the master TXOP duration 510. In some aspects, the AP grants STA2 medium access for a slave TXOP duration 514 between times t₉ and t₁₀. STA2 transmits data 506 using the MRU 520 during the slave TXOP duration 514. After expiration of the slave TXOP duration 514 at time t₁₀, control of the wireless medium returns to the AP.

In some aspects, the slave TXOP durations 512 and 514 may be of fixed time periods. In other aspects, the time periods of slave TXOP durations 512 and 514 may be based on traffic conditions and/or the priority levels of data 504 and data 506.

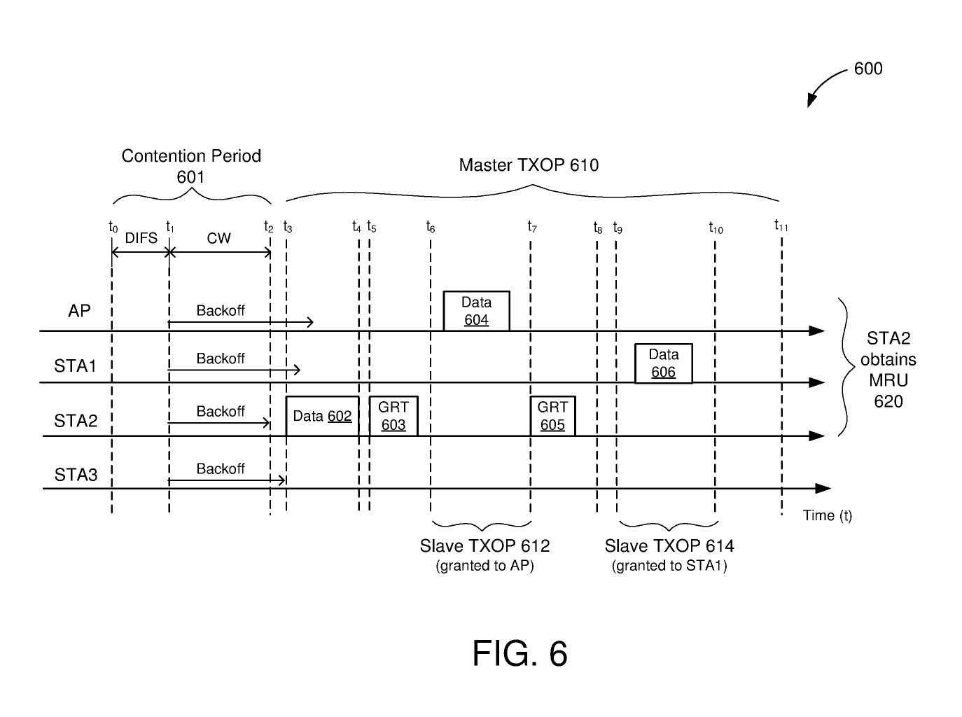

FIG. 6 is a timing diagram depicting another example operation 600 for managing access to a wireless medium, in accordance with example embodiments. For the example of FIG. 6, the AP may be any suitable AP including, for example, the AP 110 of FIG. 1 and/or the AP 300 of FIG. 3. Each of the stations STA1-STA3 may be any suitable wireless station including, for example, the stations STA1-STA4 of FIG. 1 and/or the STA 200 of FIG. 2.

As depicted in FIG. 6, STA2 obtains a MRU 620 for a master TXOP duration 610, and may control medium access via the MRU 620 for the master TXOP duration 610. More specifically, the AP and stations STA1-STA3 may contend with each other for medium access during a contention period 601. After sensing that the wireless medium has been continuously idle for a DIFS interval between times t₀ and t₁, the AP and stations STA1-STA3 may each select a random back-off number. After a back-off period determined by its selected back-off number, each of the AP and stations STA1-STA3 may then attempt to gain access to the wireless medium. For the example of FIG. 6, STA2 has the shortest back-off period (e.g., corresponding to a contention window (CW) between times t₁ and t₂), and gains access to the wireless medium at time t₂. Thus, at time t₂, STA2 may obtain the MRU 620 for the master TXOP duration 610 between times t₃ and t₁₁.

STA2 may transmit data using the obtained MRU 620 and/or may selectively schedule a grant of the obtained MRU 620 to the AP and stations STA1 and STA3 during the master TXOP duration 610. For the example of FIG. 6, STA2 transmits data 602 on the wireless medium during a first interval (e.g., between times t₃ and t₄) of the master TXOP duration 610. After transmitting the data 602, STA2 may schedule a grant of the obtained MRU 620 to the AP and stations STA1 and STA3 during a second interval of the obtained master TXOP duration 610 (e.g., during a remainder of the master TXOP duration 610 between times t₆ and t₁₁). For other implementations, STA2 may grant medium access to the AP and stations STA1 and STA3 using a polling operation.

Specifically, for the example of FIG. 6, STA2 transmits a first grant message 603 to the AP at time t₅. The first grant message 603 may grant the MRU 620 to the AP for a first portion of the second interval of the master TXOP duration 610. In some aspects, STA2 grants the AP medium access for a slave TXOP duration 612 between times t₆ and t₇. The AP transmits data 604 using the MRU 620 during the slave TXOP duration 612. After expiration of the slave TXOP duration 612 at time t₇, control of the wireless medium returns to STA2.

At time t₈, STA2 transmits a second grant message 605 to STA1. The second grant message 605 may grant the MRU 620 to STA1 for a second portion of the second interval of the master TXOP duration 610. In some aspects, STA2 grants STA1 medium access for a slave TXOP duration 614 between times t₉ and t₁₀. STA1 transmits data 606 using the MRU 620 during the slave TXOP duration 614. After expiration of the slave TXOP duration 614 at time t₁₀, control of the wireless medium returns to STA2.

In some aspects, the slave TXOP durations 612 and 614 may be of fixed time periods. In other aspects, the time periods of slave TXOP durations 612 and 614 may be based on traffic conditions and/or the priority levels of data 604 and data 606.

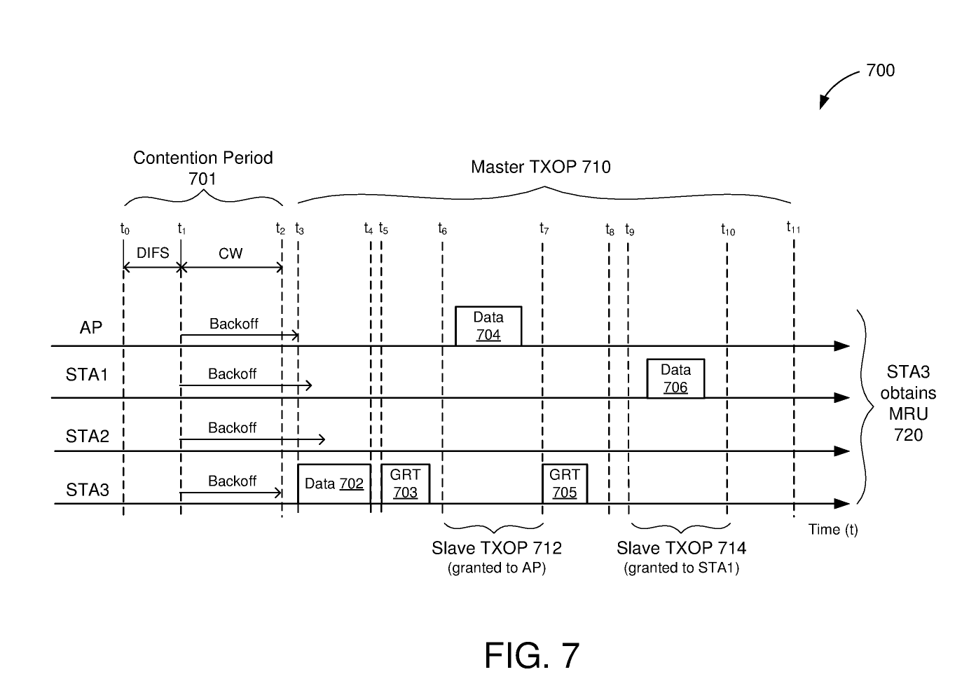

FIG. 7 is a timing diagram depicting another example operation 700 for managing access to a wireless medium, in accordance with example embodiments. For the example of FIG. 7, the AP may be any suitable AP including, for example, the AP 110 of FIG. 1 and/or the AP 300 of FIG. 3. Each of the stations STA1-STA3 may be any suitable wireless station including, for example, the stations STA1-STA4 of FIG. 1 and/or the STA 200 of FIG. 2.

As depicted in FIG. 7, STA3 obtains a MRU 720 for a master TXOP duration 710, and may control medium access via the MRU 720 for the master TXOP duration 710. More specifically, the AP and stations STA1-STA3 may contend with each other for medium access during a contention period 701. After sensing that the wireless medium has been continuously idle for a DIFS interval between times t₀ and t₁, the AP and stations STA1-STA3 may each select a random back-off number. After a back-off period determined by its selected back-off number, each of the AP and stations STA1-STA3 may then attempt to gain access to the wireless medium. For the example of FIG. 7, STA3 has the shortest back-off period (e.g., corresponding to a contention window (CW) between times t₁ and t₂), and gains access to the wireless medium at time t₂. Thus, at time t₂, STA3 may obtain the MRU 720 for the master TXOP duration 710 between times t₃ and t₁₁.

STA3 may transmit data using the obtained MRU 720 and/or may selectively schedule a grant of the obtained MRU 720 to the AP and stations STA1-STA2 during the master TXOP duration 710. For the example of FIG. 7, STA3 transmits data 702 on the wireless medium during a first interval (e.g., between times t₃ and t₄) of the master TXOP duration 710. After transmitting the data 702, STA3 may schedule a grant of the obtained MRU 720 to the AP and stations STA1-STA2 during a second interval of the obtained master TXOP duration 710 (e.g., during a remainder of the master TXOP duration 710 between times t₅ and t₁₁). For other implementations, STA3 may grant medium access to the AP and stations STA1-STA2 using a polling operation.

Specifically, for the example of FIG. 7, STA3 transmits a first grant message 703 to the AP at time t₅. The first grant message 703 may grant the MRU 720 to the AP for a first portion of the second interval of the master TXOP duration 710. In some aspects, STA3 grants the AP medium access for a slave TXOP duration 712 between times t₆ and t₇. The AP transmits data 704 using the MRU 720 during the slave TXOP duration 712. After expiration of the slave TXOP duration 712 at time t₇, control of the wireless medium returns to STA3.

At time t₈, STA3 transmits a second grant message 705 to STA2. The second grant message 705 may grant the MRU 720 to STA1 for a second portion of the second interval of the master TXOP duration 710. In some aspects, the AP grants STA1 medium access for a slave TXOP duration 714 between times t₉ and t₁₀. STA1 transmits data 706 using the MRU 720 during the slave TXOP duration 714. After expiration of the slave TXOP duration 714 at time t₁₀, control of the wireless medium returns to STA3.

In some aspects, the slave TXOP durations 712 and 714 may be of fixed time periods. In other aspects, the time periods of slave TXOP durations 712 and 714 may be based on traffic conditions and/or the priority levels of data 704 and data 706.

FIG. 8 shows an illustrative flow chart depicting an example operation 800 of a first wireless device managing access to a shared wireless medium, in accordance with example embodiments. For the example operation 800, the first wireless devices may be an access point (e.g., AP 110 of FIG. 1 or AP 300 of FIG. 3), and at least one of the second wireless devices may be a mobile station (e.g., one of stations STA1-STA4 of FIG. 1 or STA 200 of FIG. 2). For other implementations, the first wireless device may be a mobile station (e.g., one of stations STA1-STA4 of FIG. 1 or STA 200 of FIG. 2), and the second wireless devices may each be either an access point (e.g., AP 110 of FIG. 1 or AP 300 of FIG. 3) or another station.

As described above, the first wireless device may contend for access to the wireless medium using a random channel access mechanism (802). For some implementations, the second wireless devices may contend for medium access using the same random channel access mechanism as the first wireless device. The first wireless device may employ any suitable random channel access mechanism. In some aspects, the random channel access mechanism may be based on a CSMA/CA mechanism such as, for example, the EDCA mechanism specified in the IEEE 802.11 standards. In other aspects, other suitable random channel access mechanisms may be used by the first wireless device to contend for medium access.

The first wireless device may obtain a medium resource unit (MRU) for a master transmit opportunity (TXOP) duration based on the contending (804). In some aspects, the master TXOP duration may be one of master TXOP duration 510 of FIG. 5, master TXOP duration 610 of FIG. 6, and master TXOP duration 710 of FIG. 7. The MRU may be or include any suitable number of wireless channels, frequencies, frequency subcarriers, or other wireless resources. For example, in at least some implementations, the MRU may be one or more of a primary 20 MHz channel, a primary 40 MHz channel, an 80 MHz channel, a 160 MHz channel, an 80+80 MHz channel, and one or more secondary channels.

Then, the first wireless device may selectively transmit data on the wireless medium, using the obtained MRU, during a first interval of the master TXOP duration (806). Referring also to FIG. 5, the data transmitted by the first wireless device may correspond to the data 502, and the first interval of the master TXOP duration may correspond to the time period between times t₃ and t₄. For example, if the first wireless device has queued data for transmission, the first wireless device may transmit the queued data using the obtained MRU. Conversely, if the first wireless device does not have queued data for transmission, the first wireless device may not transmit any data using the obtained MRU, but instead may grant access to the wireless medium to one or more second wireless devices during the first interval. In this manner, the one or more second wireless devices may transmit data on the wireless medium using the obtained MRU.

Then, the first wireless device may schedule a grant of the obtained MRU to a second wireless device during a second interval of the master TXOP duration (808). Referring also to FIG. 5, the second interval of the master TXOP duration may correspond to the time interval between times t₆ and t₁₁.

Next, the first wireless device may grant, to a number of second wireless devices (wherein the number is greater than one), the MRU for a corresponding one of a number of slave TXOP durations (810). For some implementations, the first wireless device may grant medium access to the second wireless devices by transmitting grant messages to the second wireless devices. For example, referring again to FIG. 5, the first wireless device may grant medium access to STA1 by transmitting a first grant message 503 to STA1, and may grant medium access to STA2 by transmitting a second grant message 505 to STA2.

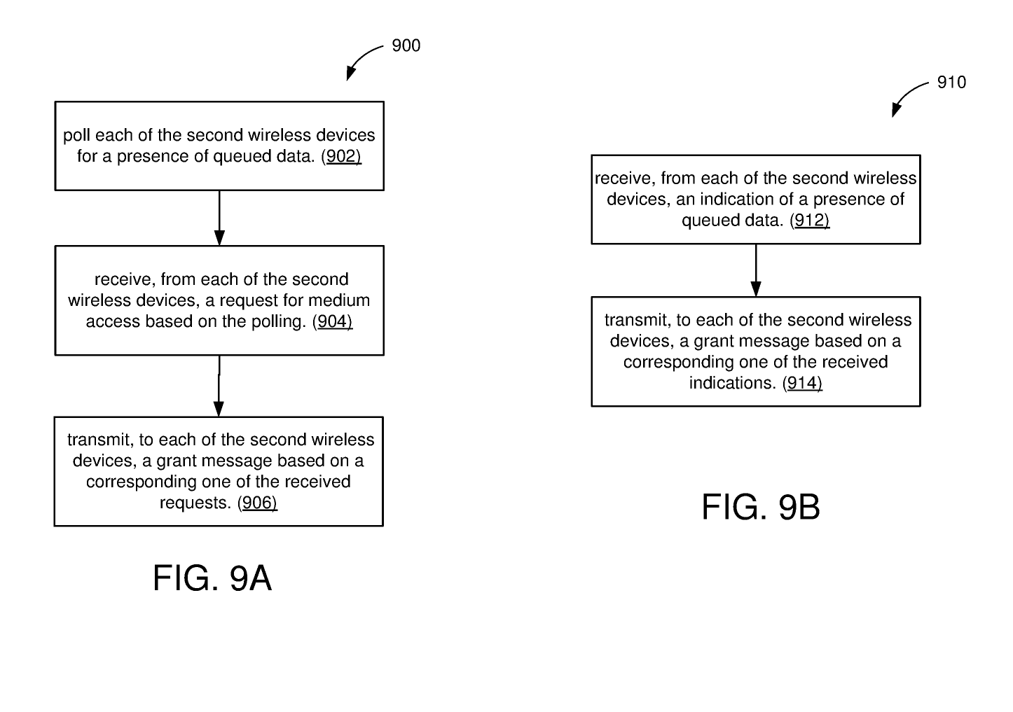

In some aspects, the first wireless device may employ a polling mechanism to grant medium access to the second wireless devices. For example, referring to the example flow chart 900 of FIG. 9A, the first wireless device may poll each of the number of second wireless devices for a presence of queued data (902). In some aspects, the first wireless device may transmit a polling frame or a trigger frame that may cause the second wireless devices to request medium access. Then, the first wireless device may receive, from each of the number of second wireless devices, a request for medium access based on the polling (904). Thereafter, the first wireless device may transmit, to each of the number of second wireless devices, a grant message based on a corresponding one of the received requests (906).

In other aspects, the first wireless device may schedule medium access for the second wireless devices. For example, referring to the example flow chart 910 of FIG. 9B, the first wireless device may receive, from each of the number of second wireless devices, an indication of a presence of queued data (912). Then, the first wireless device may transmit, to each of the number of second wireless devices, a grant message based on a corresponding one of the received indications (914).

Referring again to FIG. 8, the first wireless device may receive, from each of the number of second wireless devices, data on the granted MRU during the corresponding slave TXOP duration (812).

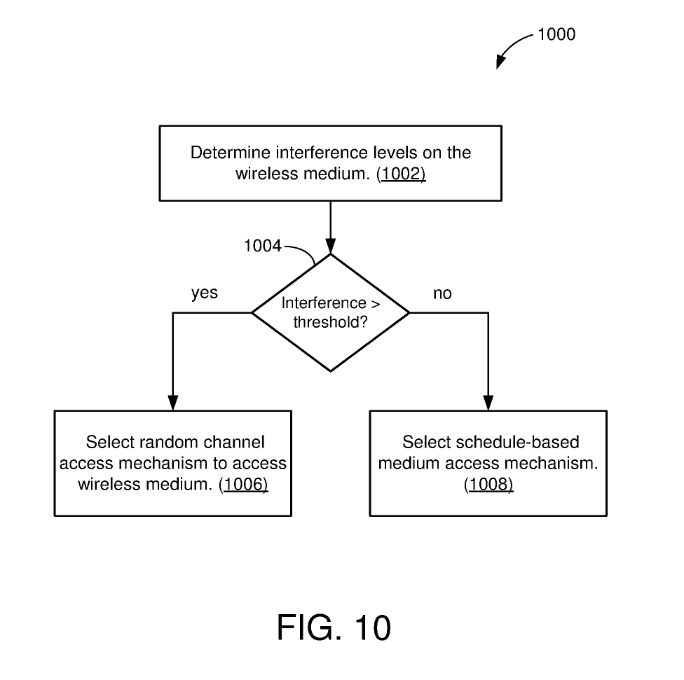

FIG. 10 shows an illustrative flow chart depicting an example operation 1000 for a wireless device to select between channel access mechanisms, in accordance with example embodiments. For the example operation 1000, the wireless devices may be an access point (e.g., AP 110 of FIG. 1 or AP 300 of FIG. 3) or a mobile station (e.g., one of stations STA1-STA4 of FIG. 1 or STA 200 of FIG. 2).

First, the wireless device may determine interference levels or channel conditions on the wireless medium (1002). The wireless device may determine interference levels or channel conditions on the wireless medium in any suitable manner. In some aspects, the wireless device may use polling operations to determine or otherwise measure interference levels and/or channel conditions. In other aspects, the wireless device may use CCA operations to determine or otherwise measure interference levels and/or channel conditions.

If the determined level of interference is greater than a threshold, as tested at 1004, then the wireless device may select a random channel access mechanism to obtain access to the wireless medium (1006). As described above, random channel access mechanisms may be less susceptible to interference and changing channel conditions than schedule-based medium access mechanisms, and therefore may be more efficient than schedule-based medium access mechanisms when interference levels are above the threshold.

Conversely, if the determined level of interference is not greater than the threshold, as tested at 1004, then the wireless device may select a schedule-based medium access mechanism to obtain access to the wireless medium (1008). As described above, schedule-based medium access 8 mechanisms do not involve polling operations, and therefore typically use less overhead for grants of medium access than random channel access mechanisms. As a result, schedule-based medium access mechanisms may be more efficient than random channel access mechanisms.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth herein. The specification and drawings are, accordingly, to be regarded in an illustrative sense rather than a restrictive sense.

What is claimed is:

1. A method of managing access to a wireless medium associated with a wireless network, the method performed by a first wireless device and comprising:
contending for access to the wireless medium using a random channel access mechanism;
obtaining a medium resource unit (MRU) for a master transmit opportunity (TXOP) duration based on the contending;
selectively transmitting data on the wireless medium, using the obtained MRU, during a first interval of the master TXOP duration; and
scheduling a grant of the obtained MRU to a second wireless device during a second interval of the master TXOP duration.

2. The method of claim 1, wherein the MRU comprises at least one member of the group consisting of a primary 20 MHz channel, a primary 40 MHz channel, a primary 80 MHz channel, a 160 MHz channel, an 80+80 MHz channel, and one or more secondary channels.

3. The method of claim 1, further comprising:
granting, to a number of second wireless devices, the MRU for a corresponding one of a number of slave TXOP durations, wherein the number is greater than one.

4. The method of claim 3, wherein each of the number of slave TXOP durations is based on at least one member of the group consisting of a number of wireless devices contending for medium access, a number of wireless devices associated with the wireless network, and a traffic level on the wireless medium.

5. The method of claim 3, wherein the granting comprises:
polling each of the number of second wireless devices for a presence of queued data;
receiving, from each of the number of second wireless devices, a request for medium access based on the polling; and
transmitting, to each of the number of second wireless devices, a grant message based on a corresponding one of the received requests.

6. The method of claim 3, wherein the granting comprises:
receiving, from each of the number of second wireless devices, an indication of a presence of queued data; and
transmitting, to each of the number of second wireless devices, a grant message based on a corresponding one of the received indications.

7. The method of claim 3, further comprising:
receiving, from each of the number of second wireless devices, data on the granted MRU during the corresponding slave TXOP duration.

8. The method of claim 1, wherein the first wireless device comprises an access point, and the second wireless device comprises a high-efficiency station (HE STA) compliant with the IEEE 802.11ax standards.

9. The method of claim 8, wherein the first wireless device contends for access to the wireless medium with the number of second wireless devices and with at least one third wireless device that comprises a non-HE STA.

10. A first wireless device for managing access to a wireless medium associated with a wireless network, the first wireless device comprising:
one or more processors; and
a memory storing instructions that, when executed by the one or more processors, cause the first wireless device to:
contend for access to the wireless medium using a random channel access mechanism;
obtain a medium resource unit (MRU) for a master transmit opportunity (TXOP) duration based on the contending;
selectively transmit data on the wireless medium, using the obtained MRU, during a first interval of the master TXOP duration; and
schedule a grant of the obtained MRU to a second wireless device during a second interval of the master TXOP duration.

11. The first wireless device of claim 10, wherein the MRU comprises at least one member of the group consisting of a primary 20 MHz channel, a primary 40 MHz channel, a primary 80 MHz channel, a 160 MHz channel, an 80+80 MHz channel, and one or more secondary channels.

12. The first wireless device of claim 10, wherein execution of the instructions further causes the first wireless device to:
grant, to a number of second wireless devices, the MRU for a corresponding one of a number of slave TXOP durations, wherein the number is greater than one.

13. The first wireless device of claim 12, wherein each of the number of slave TXOP durations is based on at least one member of the group consisting of a number of wireless devices contending for medium access, a number of wireless devices associated with the wireless network, and a traffic level on the wireless medium.

14. The first wireless device of claim 12, wherein execution of the instructions to grant causes the first wireless device to:
poll each of the number of second wireless devices for a presence of queued data;
receive, from each of the number of second wireless devices, a request for medium access based on the polling; and
transmit, to each of the number of second wireless devices, a grant message based on a corresponding one of the received requests.

15. The first wireless device of claim 12, wherein execution of the instructions to grant access causes the first wireless device to:
receive, from each of the number of second wireless devices, an indication of a presence of queued data; and
transmit, to each of the number of second wireless devices, a grant message based on a corresponding one of the received indications.

16. The first wireless device of claim 12, wherein execution of the instructions further causes the first wireless device to:
receive, from each of the number of second wireless devices, data on the granted MRU during the corresponding slave TXOP duration.

17. The first wireless device of claim 10, wherein the first wireless device contends for access to the wireless medium with a number of second wireless devices and with at least one third wireless device, wherein:
the first wireless device comprises an access point;
at least one of the number of second wireless devices comprises a high-efficiency station (HE STA) compliant with the IEEE 802.11ax standards; and
the at least one third wireless device comprises a non-HE STA.

18. A non-transitory computer-readable storage medium configured to store instructions that, when executed by one or more processors of a first wireless device, cause the first wireless device to manage access to a wireless medium by performing operations comprising:
contending for access to the wireless medium using a random channel access mechanism;
obtaining a medium resource unit (MRU) for a master transmit opportunity (TXOP) duration based on the contending;
selectively transmitting data on the wireless medium, using the obtained MRU, during a first interval of the master TXOP duration; and
scheduling a grant of the obtained MRU to a second wireless device during a second interval of the master TXOP duration.

19. The non-transitory computer-readable storage medium of claim 18, wherein execution of the instructions further causes the first wireless device to perform operations further comprising:
granting, to a number of second wireless devices, the MRU for a corresponding one of a number of slave TXOP durations, wherein the number is greater than one.

20. The non-transitory computer-readable storage medium of claim 19, wherein each of the number of slave TXOP durations is based on at least one member of the group consisting of a number of wireless devices contending for medium access, a number of wireless devices associated with a wireless network, and a traffic level on the wireless medium.

21. The non-transitory computer-readable storage medium of claim 19, wherein execution of the instructions for granting causes the first wireless device to perform operations further comprising:
polling each of the number of second wireless devices for a presence of queued data;
receiving, from each of the number of second wireless devices, a request for medium access based on the polling; and
transmitting, to each of the number of second wireless devices, a grant message based on a corresponding one of the received requests.

22. The non-transitory computer-readable storage medium of claim 19, wherein execution of the instructions for granting causes the first wireless device to perform operations further comprising:
receiving, from each of the number of second wireless devices, an indication of a presence of queued data; and
transmitting, to each of the number of second wireless devices, a grant message based on a corresponding one of the received indications.

23. The non-transitory computer-readable storage medium of claim 19, wherein execution of the instructions causes the first wireless device to perform operations further comprising:
receiving, from each of the number of second wireless devices, data on the granted MRU during the corresponding slave TXOP duration.

24. The non-transitory computer-readable storage medium of claim 18, wherein the first wireless device contends for access to the wireless medium with a number of second wireless devices and with at least one third wireless device, and:
the first wireless device comprises an access point;
at least one of the number of second wireless devices comprises a high-efficiency station (HE STA) compliant with the IEEE 802.11ax standards; and
the at least one third wireless device comprises a non-HE STA.

25. A first wireless device for managing access to a shared wireless medium associated with a wireless network, the first wireless device comprising:
means for contending for access to the wireless medium using a random channel access mechanism;
means for obtaining a medium resource unit (MRU) for a master transmit opportunity (TXOP) duration based on the contending;
means for selectively transmitting data on the wireless medium, using the obtained MRU, during a first interval of the master TXOP duration; and
means for scheduling a grant of the obtained MRU to a second wireless device during a second interval of the master TXOP duration.

26. The first wireless device of claim 25, further comprising:
means for granting, to a number of second wireless devices, the MRU for a corresponding one of a number of slave TXOP durations, wherein the number is greater than one.

27. The first wireless device of claim 26, wherein the means for granting is to:
poll each of the number of second wireless devices for a presence of queued data;
receive, from each of the number of second wireless devices, a request for medium access based on the polling; and
transmit, to each of the number of second wireless devices, a grant message based on a corresponding one of the received requests.

28. The first wireless device of claim 26, wherein the means for granting is to:
receive, from each of the number of second wireless devices, an indication of a presence of queued data; and
transmit, to each of the number of second wireless devices, a grant message based on a corresponding one of the received indications.

29. The first wireless device of claim 26, further comprising:
means for receiving, from each of the number of second wireless devices, data on the granted MRU during the corresponding slave TXOP duration.

30. The first wireless device of claim 26, wherein the first wireless device contends for access to the wireless medium with a number of second wireless devices and with at least one third wireless device, wherein:
the first wireless device comprises an access point;
at least one of the number of second wireless devices comprises a high-efficiency station (HE STA) compliant with the IEEE 802.11ax standards; and
the at least one third wireless device comprises a non-HE STA.
